(19) United States
(12) Patent Application Publication
(10) Pub. No.: US 2005/0080664 A1
(43) Pub. Date: Apr. 14, 2005

(54) Methods, systems and computer program products for monitoring progression through a service order process

(76) Inventor: Gary Marr, Marietta, GA (US)

Correspondence Address: MYERS BIGEL SIBLEY & SAJOVEC, P.A., P.O. BOX 37428, RALEIGH, NC, 27627, US

(21) Appl. No.: 10/685,190

(22) Filed: Oct. 14, 2003

(51) Int. Cl. G06F 17/60

(52) U.S. Cl. 705/11

(57) ABSTRACT

A service order processing in a service order process, e.g., an end user migration (EUM) process, is monitored. Respective series of successive time samples of service order information for respective service orders of a population of service orders are generated, the service order information including respective status identifiers that indicate a relationship of respective service orders to a stage of the service order process. Transitions in the status identifiers are identified. Records of the identified transitions and corresponding times of the transitions are stored and analyzed to determine completion intervals for the stages. An aggregate measure of progression of the population of status orders through the service order process is computed from the determined completion intervals. The computed aggregate measure may be stored in a spreadsheet. The invention may be embodied as methods, systems and computer program products.

### BACKGROUND OF THE INVENTION

The present invention is directed to systems, methods and computer program products for managing services, and more particularly, to systems, methods and computer program products for monitoring service order processing.

The Telecommunications Act of 1996, enacted by the U.S. Congress on Feb. 1, 1996, and signed into law on Feb. 8, 1996, provided major changes in laws affecting cable TV, telecommunications, and the Internet. The law was intended to phase out regulated telephone service monopolies and to stimulate competition in telecommunication services by creating a market for telecommunications services.

One aspect of the Act was the creation of new requirements on service providers to provide end users with the ability to easily migrate between telecommunications service providers. For example, the Act provides for Local Number Portability (LNP), the ability of a telephone customer in the U.S. to retain their local phone number if they switch to another local telephone service provider. The idea is that by removing the personal inconvenience of having to get a new phone number when changing service providers, competition among providers will be increased. This and other requirements under the Act, along with an increase in the number and type of telecommunications service offerings (e.g., data and video services), have generally led to a commoditization of telecommunications services. Consequently, the telecommunications services market has become more driven by service, e.g., the ability to quickly migrate users in and out of telecommunications service plans.

### SUMMARY OF THE INVENTION

According to some embodiments of the invention, service order processing in a service order process, e.g., a telecommunications services end user migration (EUM) process, is monitored. Respective series of successive time samples of service order information for respective service orders of a population of service orders are generated, the service order information including respective status identifiers that indicate a relationship of respective service orders to a stage of the service order process. Transitions in the status identifiers are identified. Records of the identified transitions and corresponding times of the transitions are stored and analyzed to determine completion intervals for the stages. An aggregate measure of progression of the population of status orders through the service order process is computed from the determined completion intervals. The computed aggregate measure may be stored in a spreadsheet.

In further embodiments, service order information for the population of service orders is stored in a first database. The respective series of successive time samples of service order information are generated by extracting service order information for the population of service orders from the first database for a first time, storing the extracted service order information for the first time in a second database, extracting service order information for the population of service orders from the first database for a second time succeeding the first time, and storing the extracted service order data for the second time in the second database. The extracted service order status identifiers for the first time are compared to the extracted service order status identifiers for the second time to identify at least one transition in a service order status identifier for at least one service order. The first database may comprise an Informix® database, and the second database may comprise a Microsoft® Access database.

In further embodiments of the invention, analyzing the stored records of the identified transitions to identify completion intervals for the stages comprises determining, for the respective service orders, respective completion intervals between a first transition when a service order first arrives at a first stage and a second transition when the service order moves from a second stage following the first stage and on to a third stage following the second stage, and storing the determined completion intervals in the second database. The aggregate measure of progression of the population of status orders through the stages may be computed from the identified completion intervals by computing an average of the stored completion intervals.

In further embodiments of the invention, a system for monitoring service order processing in a service order process may be provided. The system includes a service order database configured to stored service order information for a population of service orders, the service order information including respective status identifiers that indicate a relationship of respective service orders to a stage of the service order process. The system further includes a service order monitor operative to generate respective series of successive time samples of service order information for respective service orders of the population of service orders, to identify transitions in the status identifiers over the sets of service orders, to store records of the identified transitions and corresponding times of the transitions, to analyze the stored records of the identified transitions to determine completion intervals for the stages, and to compute an aggregate measure of progression of the population of status orders through the stages from the determined completion intervals.

In additional embodiments, a computer program product for monitoring service order processing in a service order process may be provided. The computer program product comprises computer code embodied in a storage medium. The computer code comprises code configured to generate respective series of successive time samples of service order information for respective service orders of a population of service orders, the service order information including respective status identifiers that indicate a relationship of respective service orders to a stage of the service order process. The computer code further comprises code configured to identify transitions in the status identifiers over the sets of service orders, code configured to store records of the identified transitions and corresponding times of the transitions, code configured to analyze the stored records of the identified transitions to determine completion intervals for the stages, and code configured to compute an aggregate measure of progression of the population of status orders through the stages from the determined completion intervals.

### BRIEF DESCRIPTION OF THE DRAWINGS

FIG. 1 illustrates an exemplary service order process.

FIG. 2 is a flowchart illustrating exemplary operations for monitoring a service order process according to some embodiments of the present invention.

FIG. 3 is a flowchart illustrating exemplary operations for monitoring a service order process according to further embodiments of the present invention.

FIG. 4 is a block diagram illustrating an exemplary service order process monitoring system according to further embodiments of the present invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable computer readable medium may be used including hard disks, CD-ROMs, optical storage devices, a transmission media such as those supporting the Internet or an intranet, or magnetic storage devices.

Computer program code for carrying out operations of the present invention may be written in an object oriented programming language, such as Java® or C++. However, the computer program code for carrying out operations of the present invention may also be written in conventional procedural programming languages, such as the “C” programming language or assembly language. The program code may execute entirely on the user's computer, partly on the user's computer, as a standalone software package, partly on the user's computer and partly on a remote computer, or entirely on the remote computer. In the latter scenario, the remote computer may be connected to the user's computer through a local area network (LAN) or a wide area network (WAN).

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

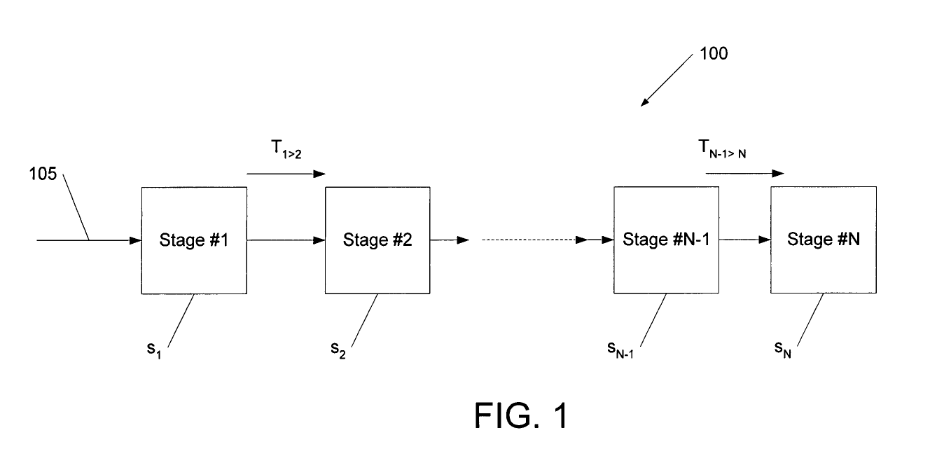

FIG. 1 illustrates an exemplary service order process 100 for which embodiments of the invention described herein may be used. The process 100 includes a plurality of stages s₁-s_{N} through which service orders 105 are passed. The stages s₁-s_{N} may comprise a variety of different operations that may be performed on and/or responsive to the service orders 105, such as processing by particular departments of an organization responsible for processing the service order. As will be appreciated by those skilled in the art, for a given service order in such a process 100, the process may toggle among the stages s₁-s_{N} while generally proceeding to completion. For example, a service order may transition back and forth between first and second stages before proceeding on to a third stage. Embodiments of the invention may be used to determine aggregate measures of completion intervals T_{1>2}, . . . , T_{N-1>N} for the service order process, e.g., statistical averages of the time intervals between completion of the various stages s₁-s_{N} of the process 100.

In some exemplary embodiments of the present invention, the process 100 may comprise a process for telecommunications service end user migration (EUM), e.g., an EUM service order process for a local exchange company (LEC) whereby telecommunications services for former customers is re-established. In this exemplary service process, service orders 105 for EUM are stored as records in an Informix® database. These records include status fields and project numbers (PRNs) that are modified as the service orders are processed. These status fields and PRNS may serve as status identifiers for the service orders with respect to the stages in the service order process.

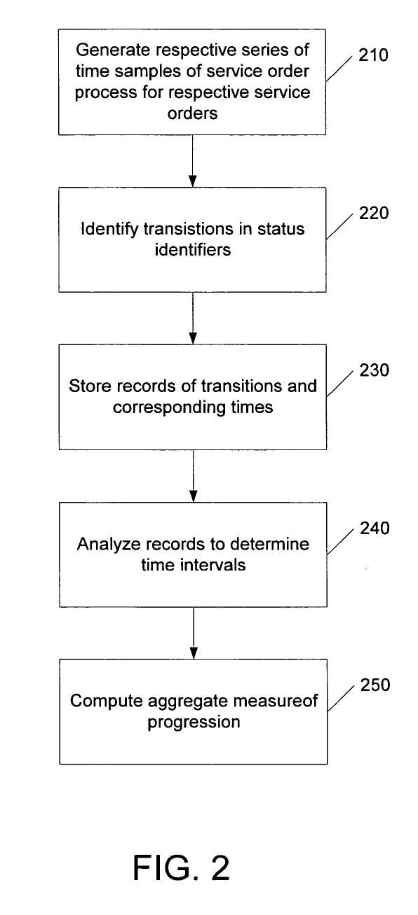

Exemplary operations for monitoring such an exemplary service order process according to some embodiments of the present invention are illustrated in FIG. 2. Respective series of time samples of the service order process for respective service orders of a population of service orders are generated (block 210). According to some embodiments described in detail below, this sampling may comprise periodically extracting service order data from a service order database that includes records that include status identifier fields that indicate where (e.g., at which stage) a service order currently resides. Transitions in such status identifiers are identified from the generated time samples (block 220), and records of the transitions and corresponding times are stored (block 230). The records are then analyzed to determine time intervals between stages in the service order process (block 240). An aggregate measure of progression through the service order process, e.g., an average time interval or other statistical measure, is then computed from the determined time intervals (block 250).

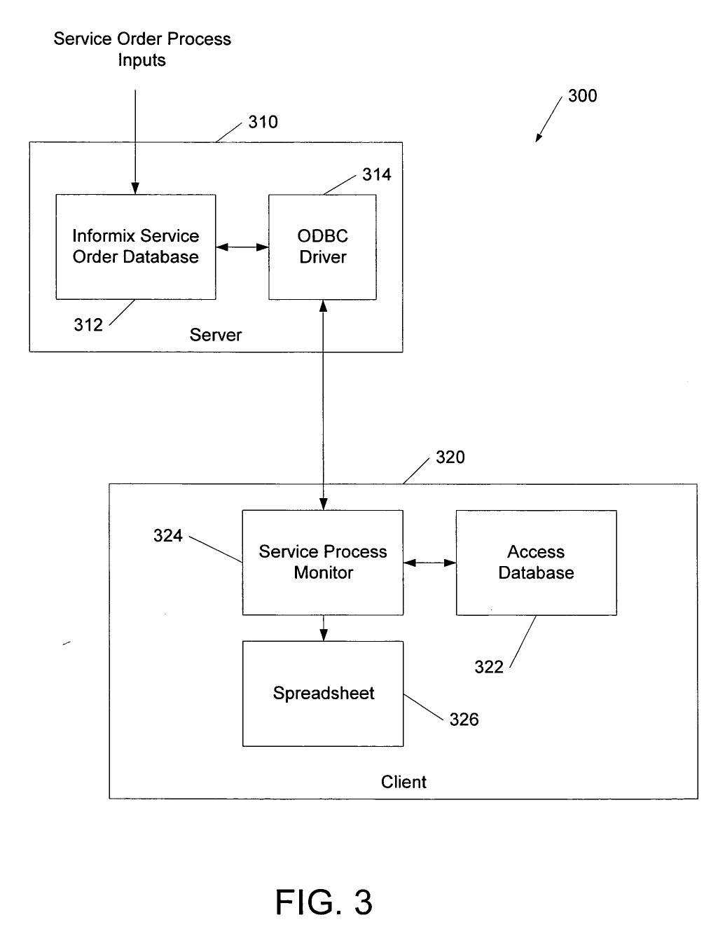

FIG. 3 illustrates an exemplary telecommunications EUM service order monitoring system 300 according to further embodiments of the present invention. The system includes a server computer 310 that hosts an Informix® service order database 312 that maintains service order information responsive to service order process inputs (e.g., manual or automatic updates to information stored in the service order database 312). An open database connectivity (ODBC) driver 314, also resident at the server 310, provides an interface between the service order database 312 and a service order process monitor 324 resident at a client computer 320. As shown, a Microsoft® Access database 322 and a Microsoft® Excel spreadsheet 326 are also resident at the client computer 320. The service order process monitor 324 is operative to extract data from the service order database 312 and to store the extracted data in the Access database 322, to compute statistics about the service order process from the extracted data, and to output the computed statistics to the spreadsheet 326. It will be appreciated that server computer 310 and/or the client computer 320 may comprise multiple interconnected computers.

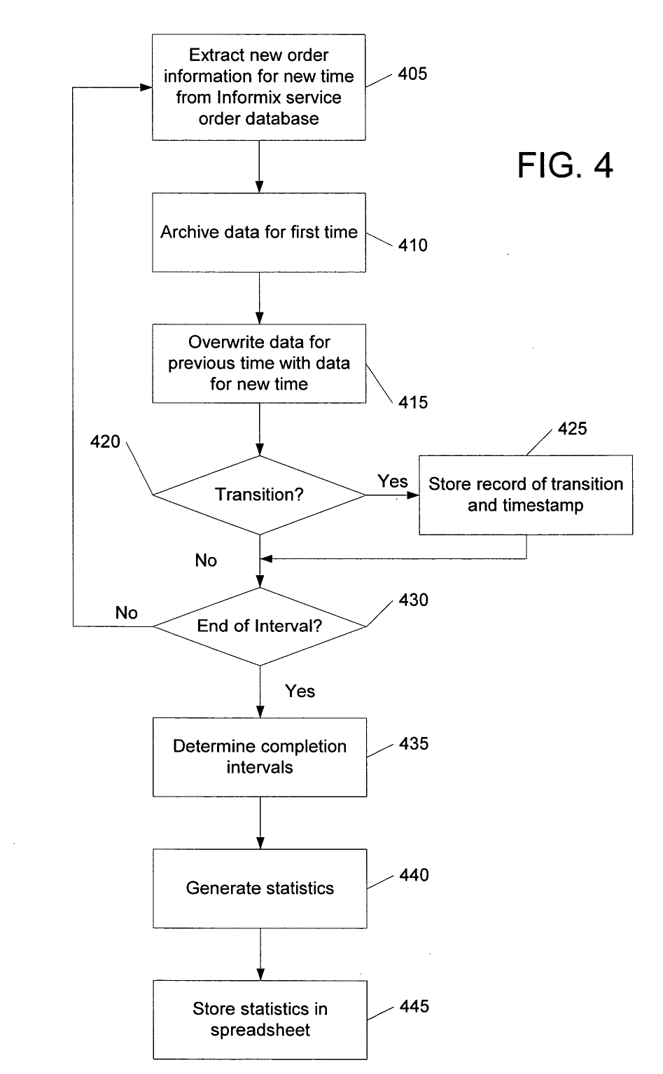

FIG. 4 illustrates exemplary operations of the system 300 of FIG. 3. At a predetermined time following a prior extraction of service order data, service order information for a new time is extracted from the service order database 312 at block 405. The previously extracted service order data (which was stored in the Access database 322) is archived in the Access database 322 before being overwritten by the newly extracted service order data (blocks 410, 415). Status identifiers for the new and archived data are compared to determine if a transition in a status identifier for the service order has occurred at block 420. If a transition is detected, a record of the transition is stored, along with a timestamp, in the Access database 322 at block 425; if not, the sampling process resumes at block 405. Upon detection of the end of a sampling interval at block 430, the service order process monitor 324 determines completion intervals for service orders being processed according to the service order process at block 435, e.g., using an algorithm that recognizes patterns in the transitions that indicate progression of the service orders through stages in the service order process. An exemplary algorithm, for example, might identify a first event representing initial passage of a service order from a first stage to a second stage, and a second event representing passage on to a third stage, and identify a completion interval as a time interval between the first and second events. It will be appreciated, however, that other algorithms may be used, depending, for example, on the nature of the service order process and/or the type of completion interval data desired. Referring again to FIG. 4, a statistic, e.g., an average or other statistical measure, is then computed from such completion intervals at block 440, and stored in a spreadsheet at block 445. It will be appreciated that the systems and operations described with reference to FIGS. 3 and 4 are provided for exemplary purposes, and that the invention encompasses other arrangements of operations, other system configurations, and/or other service order processing applications.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of monitoring service order processing in a service order process, the method comprising the following acts performed in a computer:
generating respective series of successive time samples of service order information for respective service orders of a population of service orders, the service order information including respective status identifiers that indicate a relationship of respective service orders to a stage of the service order process;
identifying transitions in the status identifiers;
storing records of the identified transitions and corresponding times of the transitions;
analyzing the stored records of the identified transitions to determine completion intervals for the stages; and
computing an aggregate measure of progression of the population of status orders through the service order process from the determined completion intervals.

2. A method according to claim 1:
wherein service order information for the population of service orders is stored in a first database;
wherein generating respective series of successive time samples of service order information for respective service orders of a population of service orders comprises:
extracting service order information for the population of service orders from the first database for a first time;
storing the extracted service order information for the first time in a second database;
extracting service order information for the population of service orders from the first database for a second time succeeding the first time; and
storing the extracted service order data for the second time in the second database;
wherein identifying transitions in the status identifiers over the sets of service orders comprises comparing the extracted service order status identifiers for the first time to the extracted service order status identifiers for the second time to identify at least one transition in a service order status identifier for at least one service order.

3. A method according to claim 2:
wherein storing the extracted service order data for the second time in the second database is preceded by archiving the service order data for the first time;
wherein storing the extracted service order data for the second time in the second database comprises overwriting the service order data for the first time with the extracted service order data for the second time; and
wherein comparing the extracted service order status identifiers for the first time to the extracted service order status identifiers for the second time to identify at least one transition in a service order status identifier for at least one service order comprises comparing the stored service order data for the second time to the archived service order data for the first time to identify at least one transition in a service order status identifier for at least one service order.

4. A method according to claim 2, wherein the first database comprises an Informix® database, and wherein the second database comprises an Access Database.

5. A method according to claim 2:
wherein analyzing the stored records of the identified transitions to identify completion intervals for the stages comprises:
determining, for the respective service orders, respective completion intervals between a first transition when a service order first arrives at a first stage and a second transition when the service order moves from a second stage following the first stage and on to a third stage following the second stage; and
storing the determined completion intervals in the second database; and
wherein computing an aggregate measure of progression of the population of status orders through the stages from the identified completion intervals comprises computing an average of the stored completion intervals.

6. A method according to claim 1, further comprising storing the computed aggregate measure in a spreadsheet.

7. A method according to claim 1, wherein the service order process comprises a local exchange carrier (LEC) end user migration (EUM) process.

8. A system for monitoring service order processing in a service order process, the system comprising:
a service order database configured to stored service order information for a population of service orders, the service order information including respective status identifiers that indicate a relationship of respective service orders to a stage of the service order process; and
a service order monitor operative to generate respective series of successive time samples of service order information for respective service orders of the population of service orders, to identify transitions in the status identifiers over the sets of service orders, to store records of the identified transitions and corresponding times of the transitions, to analyze the stored records of the identified transitions to determine completion intervals for the stages, and to compute an aggregate measure of progression of the population of status orders through the stages from the determined completion intervals.

9. A system according to claim 8:
wherein the service order database comprises a first database;
wherein the system further comprises a second database configured to store extracted service order information from the first database; and
wherein the service order monitor is operative to extract and store service order information for the population of service orders from the first database for a first time in the second database, to extract and stored service order information for the population of service orders from the first database for a second time succeeding the first time in the second database, and to compare the stored service order status identifiers for the first time to the stored service order status identifiers for the second time to identify at least one transition in a service order status identifier for at least one service order.

10. A system according to claim 9, wherein the first database comprises an Informix® database, and wherein the second database comprises an Access Database.

11. A system according to claim 8, further comprising a spreadsheet configured to store the computed aggregate measure.

12. A system according to claim 8, wherein the service order process comprises a local exchange carrier end user migration (EUM) process.

13. A computer program product for monitoring service order processing in a service order process, the computer program product comprising computer code embodied in a storage medium, the computer code comprising:
code configured to generate respective series of successive time samples of service order information for respective service orders of a population of service orders, the service order information including respective status identifiers that indicate a relationship of respective service orders to a stage of the service order process;
code configured to identify transitions in the status identifiers over the sets of service orders;
code configured to store records of the identified transitions and corresponding times of the transitions;
code configured to analyze the stored records of the identified transitions to determine completion intervals for the stages; and
code configured to compute an aggregate measure of progression of the population of status orders through the stages from the determined completion intervals.

14. A computer program product according to claim 13:
wherein service order information for the population of service orders is stored in a first database;
wherein the code configured to generate respective series of successive time samples of service order information for respective service orders of a population of service orders comprises code configured to extract and store service order information for the population of service orders from the first database for a first time, and to extract and store service order information for the population of service orders from the first database for a second time succeeding the first time; and
wherein the code configured to identify transitions in the status identifiers over the sets of service orders comprises code configured to compare the extracted service order status identifiers for the first time to the extracted service order status identifiers for the second time to identify at least one transition in a service order status identifier for at least one service order.

15. A computer program product according to claim 14:
wherein the code configured to analyze the stored records of the identified transitions to identify completion intervals for the stages comprises:
code configured to determine, for the respective service orders, respective completion intervals between a first transition when a service order first arrives at a first stage and a second transition when the service order moves from a second stage following the first stage and on to a third stage following the second stage; and
code configured to store the determined completion intervals in the second database; and
wherein the code configured to compute an aggregate measure of progression of the population of status orders through the stages from the identified completion intervals comprises code configured to compute an average of the stored completion intervals.

16. A computer program product according to claim 13, further comprising code configured to store the computed aggregate measure in a spreadsheet.

17. A computer program product according to claim 13, wherein the service order process comprises a local exchange carrier end user migration (EUM) process.
